(19) United States
(12) Patent Application Publication
(10) Pub. No.: US 2011/0010528 A1
(43) Pub. Date: Jan. 13, 2011

(54) INFORMATION PROCESSING DEVICE AND VECTOR INFORMATION PROCESSING DEVICE

(76) Inventor: KENJI TAGATA, Kofu-shi (JP)

Correspondence Address: Mr. Jackson Chen, 6535 N. STATE HWY 161, IRVING, TX, 75039, US

(21) Appl. No.: 12/829,146

(22) Filed: Jul. 1, 2010

(30) Foreign Application Priority Data
Jul. 7, 2009 (JP) P2009-160931

(51) Int. Cl. G06F 9/30

(52) U.S. Cl. 712/217; 712/E09.016

(57) ABSTRACT

An information processing device implements a register renaming scheme for managing physical registers (e.g. hardware registers HR) coordinated with logical registers (e.g. software usable registers SUR) in conjunction with a renaming table. A first dedicated instruction is incorporated into an instruction set so that a free physical register is coordinated with a logical register designated by the first dedicated instruction. Alternatively, a second dedicated instruction is incorporated into the instruction set so that a physical register coordinated with a logical register designated by the second dedicated instruction is released to be free. In addition, the optimization is performed to change the number of software usable registers (SUR) and the number of renaming registers (RR) within the physical registers in conformity with the software executing the instruction set. Thus, it is possible to prevent the occurrence of an unwanted memory access instruction and dead time needed for releasing registers.

The present application claims priority on Japanese Patent Application No. 2009-160931 (Filing Date: Jul. 7, 2009), the content of which is incorporated herein by reference.

### BACKGROUND OF THE INVENTION

1. Field of the Invention

The present invention relates to information processing devices and vector information processing devices implementing register renaming functions.

2. Description of the Related Art

Conventionally, information processing devices have the architecture using software visible registers (SVR) such as registers open to the software (e.g. registers allowing the software to update and look up to), in which registers currently usable by the software are referred to as software usable registers (SUR). They also have the architecture using hardware registers (HR) mounted on the hardware, wherein software registers (SR) server as physical storages for software usable registers (SUR) while renaming registers (RR) serve as register renaming functions.

Even when information processing devices are equipped with processors implementing register renaming functions, the conventionally-known computer architecture is unable to change the number of software usable registers (SUR) and the number of renaming registers (RR). This indicates that programs need to be adapted to the hardware by way of an optimization scheme, thus increasing processing speeds thereof. Owing to a limitation of the optimization scheme having programs adapted to the hardware, it is necessary to save a large amount of data exceeding the limited number of register in memory. This gives rise to an additional access time, which is needed to execute a memory access instruction for saving data in memory, and latency such as a dead time needed to release registers due to the shortage of renaming registers (RR).

The optimization scheme has been further developed to manage and optimize the working conditions of logical registers in procedures for converting user-composed programs (e.g. source programs) into execute programs (e.g. object programs). The optimization scheme has been implemented in compilers (which form one constituent element of the operating system (OS)) in an optimization phase. Since compilers have an ability of performing an overall search through programs, they are able to perform optimization by way of an overall analysis of logical registers and reference registers. In contrast, the resident operation system and the hardware have a difficulty of implementing the optimization scheme because they are normally involved in prerequisite jobs for executing a series of instructions, for example, so that they likely incur overheads (i.e. unwanted processing times).

Recently, pipeline processing using vector processors have been developed to cope with a strong demand of improving throughputs in computers; this leads to a conventionally-known technology which allows a user to create software pipelining procedures so as to improve the performance and throughputs of instructions. In the case of programs including numerous steps and multiple loops, it is necessary to allocate a specific virtual resistor to each loop, which in turn increases the number of instructions in execute programs. That is, users need to perform meticulous operations to prevent collisions of logical registers during the execution of loops in an overlapped manner.

The term “users” literally refers to programmers who compose programs serving as sources of instructions or machine languages, but it may embrace a broad range of meanings, such as compilers for performing optimization in a compiler level and operating systems (OS) for controlling the hardware.

For the purpose of improving throughputs, information processing devices adopting pipeline processing need to perform register renaming functions on the hardware. Register renaming functions are needed to manage the relationship between logical registers and physical registers so as not to cause discrepancies between preceding and subsequent steps of processing even though they incur a small overhead.

Patent Document 1: Japanese Patent No. 3817436

Patent Document 1 discloses an information processing device having a register renaming function, in which consecutive numbers of physical registers are coordinated with those of logical registers and in which instruction sets include register renaming instructions. This technology aims at register remaining functions and simply allows users (e.g. programmers) to arbitrarily change the relationship between consecutive numbers of physical registers and consecutive numbers of logical registers. Even though instruction sets include specific instructions for changing the relationship between physical registers and logical registers, they do not include instructions for releasing registers; in other words, they lack an ability to change the number of renaming registers (RR).

In conventionally-known information processing devices, both the number of software usable registers (SUR) and the number of renaming registers (RR) are eigenvalues dependent upon the specifications of the hardware, which cannot be arbitrarily changed by users (e.g. programmers). Even when the hardware has free registers serving as an auxiliary storage, it is very difficult to increase the number of software usable registers (SUR) and the number of renaming registers (RR); hence, conventionally-known information processing devices are unable to demonstrate the full performance of the hardware.

### SUMMARY OF THE INVENTION

The present invention seeks to solve the above problem or to improve upon the problem at least in part since it aims at eliminating an additional memory access time and a dead time needed to release registers, which cannot be eliminated by the conventional optimization scheme simply having programs adapted to the hardware.

It is an object of the present invention to provide an information processing device and a vector information processing device equipped with a sophisticated optimization scheme having the hardware adapted to programs.

Specifically, the information processing device and the vector information processing device of the present invention handle instruction sets including dedicated instructions which allow the software to increase and/or decrease the number of unused physical registers and to efficiently utilize registers in conformity with characteristics of programs.

An information processing device of the present invention is designed to implement a register renaming scheme for managing a plurality of physical registers coordinated with a plurality of logical registers in conjunction with a renaming table.

A dedicated instruction is incorporated into an instruction set so that a physical register coordinated with a logical register designated by the dedicated instruction is released to be free.

Alternatively, a first dedicated instruction is incorporated into an instruction set so that a free physical register is coordinated with a logical register designated by the first dedicated instruction, while a second dedicated instruction is incorporated into the instruction set so that a physical register coordinated with a logical register designated by the second dedicated instruction is released to be free.

In addition, the optimization is performed to change the number of software usable registers (SUR) within the logical registers and the number of renaming registers (RR) within the physical register in conformity with the software executing the instruction set.

Preferably, the number of software usable registers (SUR) open to the software is equal to the number of physical registers.

The information processing device can be redesigned to perform vector processing via a pointer list connected to the renaming table.

In contrast to the conventionally-known technology simply optimizing programs, the present invention is able to increase/decrease the number of software usable registers (SUR) and to appropriately change the ratio between the number of software usable registers (SUR) and the number of renaming registers in conformity with the software. Thus, it is possible to efficiently use the limited amount of hardware resources in conformity with the software. In addition, it is possible to prevent the occurrence of an unwanted memory access instruction and a dead time needed for releasing registers.

### BRIEF DESCRIPTION OF THE DRAWINGS

FIG. 1 shows various usages of registers featuring characteristics of an information processing device according to an embodiment of the present invention, in which software visible registers (SVR) are coordinated with hardware registers (HR) subclassified into software registers (SR) and renaming registers (RR) in conformity with the software.

FIG. 2 shows the relationship between various sets whose registers are coordinated with each other according to conventionally-known technology.

FIG. 3 shows the relationship between various sets whose registers are coordinated with each other in a flexibly-changeable manner according to the information processing device of the present embodiment.

FIG. 4 is a block diagram showing the constitution of the information processing device of the present embodiment.

FIG. 5 shows the relationship between software usable registers and software registers, which are coordinated with each other by way of record areas of a renaming table shown in FIG. 4.

FIG. 6 shows transformation of a renaming table upon receipt of a logical register release instruction P5 shown in FIG. 4.

FIG. 7 shows a renaming operation which is initiated upon receipt of a logical register securing instruction.

FIG. 8A is a time chart illustrating the processing of a conventionally-known information processing device suffering from unwanted memory access instruction.

FIG. 8B is a time chart illustrating the processing of the information processing device of the present embodiment, which is improved in the processing performance by way of a reduction of memory access instruction.

FIG. 9A is a time chart illustrating the processing of a conventionally-known information processing device suffering from unwanted dead time for releasing registers.

FIG. 9B is a time chart illustrating the processing of the information processing device of the present embodiment, which is improved in the processing performance by way of a reduction of the dead time for releasing registers.

FIG. 10 is a block diagram showing the constitution of a vector information processing device.

### DESCRIPTION OF THE PREFERRED EMBODIMENTS

The present invention will be described in further detail by way of examples with reference to the accompanying drawings.

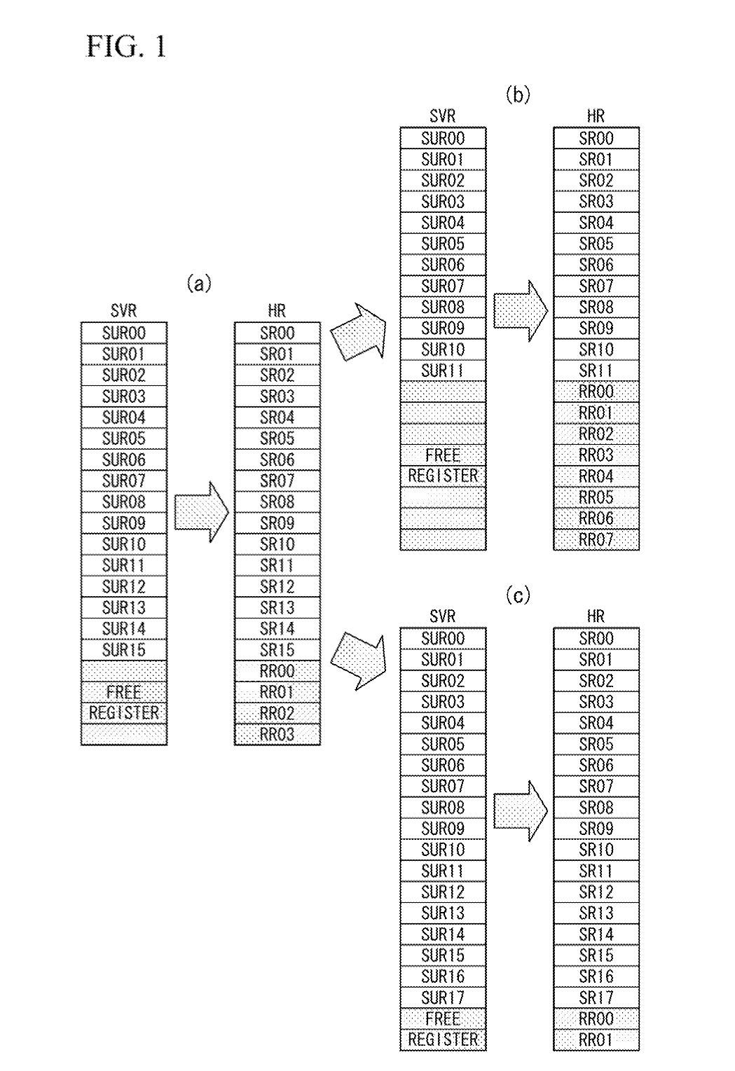

First, a register optimization method adapted to an information processing device will be described with reference to FIGS. 1 to 3.

The following description refers to the foregoing symbols used for categorizing registers, such as “SVR” representing software visible registers which are open to the software, in which “SUR” represents software usable registers which are currently usable by the software. In addition, “HR” represents hardware registers which are mounted on the hardware, in which “SR” represents software registers serving as physical storage of SUR, and “RR” represents renaming registers which are used for register renaming functions.

The present invention is able to flexibly change the number of software usable registers (SUR) and the number of renaming registers (RR) in response to the execute software (or program).

The present invention is able to reduce a dead time needed to release registers and to improve the processing performance by increasing the number of renaming registers (RR). In addition, the present invention allows the software to arbitrarily change the number of software usable registers (SUR) at the desired timing; hence, it is possible to perform optimization for precisely determining the ratio between the number of software registers (SR) and the number of renaming registers (RR) in conformity with local characteristics of programs, thus achieving a high performance of execution.

FIG. 1 illustrates various usages of registers featuring characteristics of the information processing device of the present invention, in which a set of software visible registers (SVR) is coordinated with a set of hardware registers (HR). Herein, hardware registers (HR) are subclassified into software registers (SR) used by the software and renaming registers (RR) used by the hardware. In the case of FIG. 1(a), sixteen registers out of twenty hardware registers (HR) are dedicated to software registers (SR) used by the software, while the remaining four registers which are not used by the software are dedicated to renaming registers (RR).

In the case of FIG. 1(a), the user or programmer issues a dedicated instruction (i.e. an instruction to increase or decrease the number of software visible registers (SVR) or the number of hardware registers (FIR)) included in an instruction set; hence, upon executing such a dedicated instruction, it is possible to change the number of software registers (SR) as shown in FIG. 1(b) or FIG. 1(c). The present invention allows the software to optimize the usage of registers in conformity with characteristics of programs. It is possible to prevent the occurrence of an additional memory access time needed to save data of registers in memory and a dead time needed to release registers, thus improving the processing performance.

Next, the operating principle of the present invention will be described with reference to relational expressions using the terminology of the set theory. The following description refers to the main function of the present invention for changing the number of software usable registers (SUR). Herein, “S_{SVR}” denotes a set of software visible registers (SVR), and “S_{SUR}” denotes a set of software usable registers (SUR). Each of software usable registers (SUR) constituting the set S_{SVR} is coordinated with each of registers (R) constituting an original set “H_{HR}” of hardware registers (HR) mounted on the hardware by way of bijective mapping f (i.e. a table which will be described later).

In addition, a set “H_{SR}” of registers mounted on the hardware is coordinated with the set S_{SUR} by way of the mapping f. Furthermore, registers which are not included in the set H_{SR} within the set H_{HR} are regarded as registers which can be used for a register renaming function and are categorized into a set H_{RR}. The register renaming function manipulates the mapping f so as to reorganize the relationship between the set S_{SUR} of software usable registers (SUR) and the set H_{SR} of software registers (SR) in connection with the set H_{RR} of renaming registers (RR).

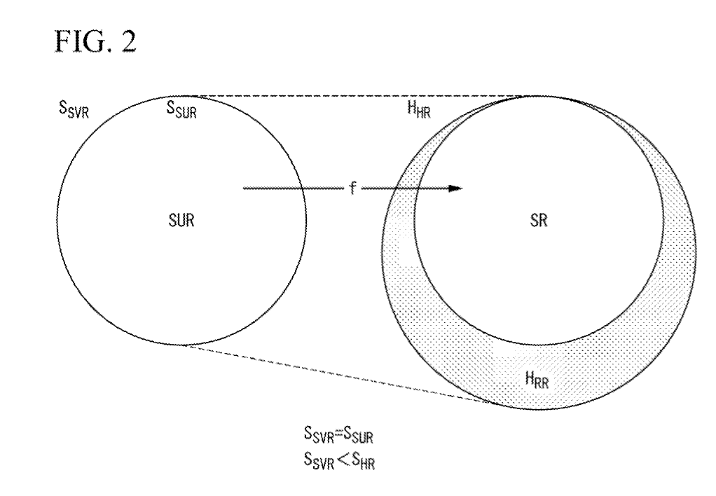

FIG. 2 illustrates the relationship between the aforementioned sets of registers which are coordinated with each other according to the conventionally-known technology, wherein symbols are expressed as follows:
(1) S_{SVR}: A set of software visible registers (SVR), i.e. registers which are visible to the software in view of the hardware.
(2) H_{HR}: A set of hardware registers (HR or R) mounted on the software.
(3) S_{SUR}=S_{SVR}
(4) H_{HR}=H_{SR}+H_{RR}
(5) f: S_{SUR}→H_{SR}

In the above, both of S_{SVR} and H_{HR} are unchanged sets which are univocally determined based on the hardware configuration.

The conventionally-known technology determines the set H_{SR} include a fixed number of software registers (SR) according to the expressions (3) and (5). Since the set H_{HR} includes a fixed number of hardware registers (HR) based on the hardware configuration, the conventionally-known technology determines the set H_{RR} include a fixed number of renaming registers (RR) according to the expression (4). In other words, each of the sets H_{SR} and H_{RR} is normally composed of a fixed number of registers, which cannot be arbitrarily changed.

In contrast to the conventionally-known technology, the present invention introduces expressions (6) to (8) so as to make it possible to change the number of registers included in each of the sets H_{SR} and H_{RR}.
(6) S_{SUR}⊂S_{SVR}
(7) H_{HR}=H_{SR}+H_{RR}
(8) f: S_{SUR}→H_{SR}

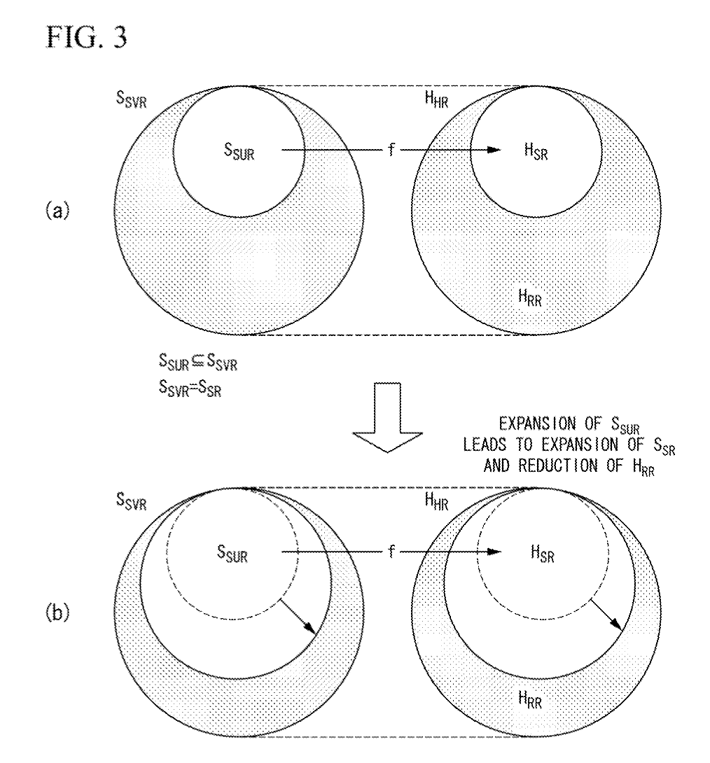

FIG. 3 shows the relationship between the aforementioned sets of registers which are coordinated with each other in an information processing device according to an embodiment of the present invention.

The expression (6) states that the set S_{SUR} is a subset of the set S_{SVR}, wherein the number of software usable registers (SUR) cannot be defined based on the above expression(s). The expression (8) states that the set H_{SR} includes an undefined number of software registers (SR) since the set S_{SUR} includes an undefined number of software usable registers (SUR). The expressions (7) and (8) state that the set H_{RR} includes an undefined number of renaming registers (RR). Upon defining the number of software usable registers (SUR) included in the set S_{SUR}, it is possible to readily define the number of registers with respect to the sets H_{SR} and H_{RR}. The present embodiment introduces an instruction for manipulating the number of software usable registers (SUR), which are used by the software, in the set S_{SUR}, thus making it possible to arbitrarily change the original number of software usable registers (SUR) included in the set S_{SUR} as well as the number of registers included in each of the sets H_{SR} and H_{RR}.

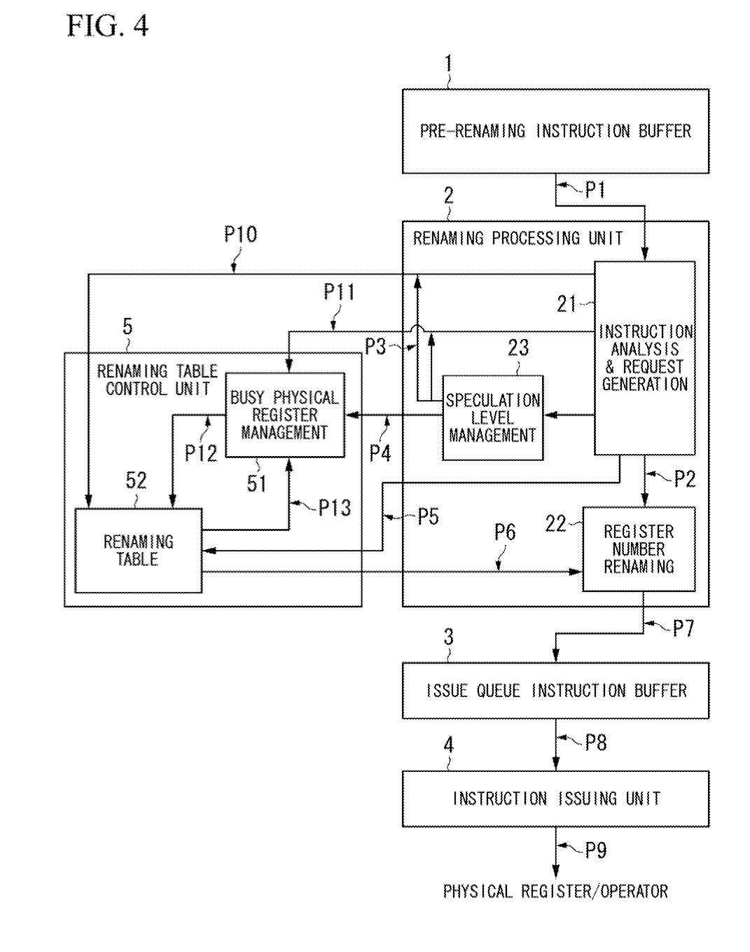

FIG. 4 is a block diagram showing the constitution of an information processing device according to the present embodiment of the present invention. The information processing device of FIG. 4 is constituted of a pre-renaming instruction buffer 1, a renaming processing unit 2, an issue queue instruction buffer 3, an instruction issuing unit 4, and a renaming table control unit 5.

The renaming processing unit 2 is constituted of an instruction analysis and request generation unit 21, a register number renaming unit 22, and a speculation level management unit 23.

The renaming table control unit 5 is constituted of a busy physical register management unit 51 and a renaming table 52.

The information processing device of FIG. 4 implements a register renaming function by way of the renaming processing unit 2 and the renaming table control unit 5; but constitution demonstrating the register renaming function is not necessarily limited to the renaming processing unit 2 and the renaming table control unit 5 in FIG. 4. It is possible to adopt other constituent elements forming a generally-known register renaming structure.

Next, the operation of the information processing device will be described in detail.

The pre-renaming instruction buffer 1 accumulates instructions fetched by a main control unit of CPU (not shown).

The renaming processing unit 2 performs a register renaming procedure with respect to instructions accumulated in the pre-renaming instruction buffer 1.

The issue queue instruction buffer 3 accumulates instructions which are already subjected to the register renaming procedure by the renaming processing unit 2.

The instruction issuing unit 4 issues instructions accumulated in the issue queue instruction buffer 3.

The renaming table control unit 5 controls the renaming table 52, whose function will be described below.

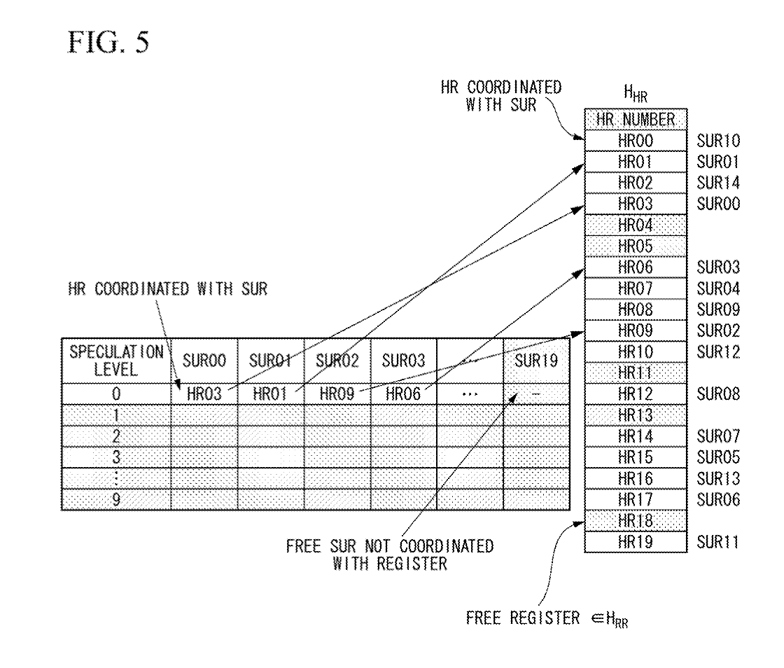

FIG. 5 shows the relationship between software usable registers (USR) and software registers (SR), which are coordinated with each other by way of record areas of the renaming table 52.

The renaming table 52 is a constituent element including various tables used for the mapping f from the set S_{SUR} to the set H_{SR}. Herein, software usable registers (SUR) are coordinated with software registers (SR) in the renaming table 52, which makes it possible to retrieve register numbers of software registers (SR) based on register numbers of software usable registers (SUR).

Next, the basic operation of the information processing device of FIG. 4, i.e. the register renaming procedure, will be described in detail. Herein, symbols “P” followed by reference numbers denote prescribed pieces of information or signals having specific names.

Instructions accumulated in the pre-renaming instruction buffer 1 are incorporated into a pre-renaming instruction P1, which is sent to the instruction analysis and request generation unit 21 of the renaming processing unit 2.

Based on the pre-renaming instruction P1, the instruction analysis and request generation unit 21 sends a new physical register securing request P11 to the busy physical register management unit 51 of the renaming table control unit 5. The new physical register securing request P11 contains the number of write-destined physical registers (i.e. the number of a write-accessed physical register).

The instruction analysis and request generation unit 21 extracts the number of a physical register (i.e. the number of a software usable register (SUR)) from the pre-renaming instruction P1. The instruction analysis and request generation unit 21 sends a physical register number request P10 to the renaming table 52 of the renaming table control unit 5. The physical register number request P10 contains the number of a read-destined logical register (i.e. the number of a hardware register (HR) or the number of a read-accessed logical register).

Upon receiving the new physical register securing request P11, the busy physical register management unit 51 of the renaming table control unit 5 checks the usage condition of physical registers so as to send a renaming table update instruction P12, incorporating a logical register number and an unused physical register number described in the new physical register securing request P11, to the renaming table 52.

Upon receiving the renaming table update instruction P12, the logical register number is coordinated with the unused physical register number in the renaming table 52. When it is already coordinated with another physical register number, the renaming table 52 sends a physical register release instruction P13, describing another physical register number, to the busy physical register management unit 51. Upon receiving the physical register release instruction P13, the busy physical register management unit 51 releases the physical register designated by P13.

Upon receiving the physical register number request P10, the renaming table 52 retrieves a physical register number based on the logical register number designated by P10. In response to the physical register number request P10 and the new physical register securing request P11, the renaming table 52 sends a physical register number reply P6 to the register number renaming unit 22 so as to notify it of the physical register numbers designated by P10 and P11.

The register number renaming unit 22 receives an instruction subsequent to extraction of the logical register number from the instruction analysis and request generation unit 21. Upon receiving the physical register number reply P6 from the renaming table 52, the register number renaming unit 22 changes the logical register number with the physical register number on the above instruction, which is thus cast into a renamed instruction P7. The register number renaming unit 22 sends the renamed instruction P7 to the issue queue instruction buffer 3.

The issue queue instruction buffer 3 accumulates instructions, based on which the instruction issuing unit 4 outputs an issue instruction P9 in an out-of-order manner.

As described above, the present embodiment is able to flexibly change the number of software usable registers (SUR) and the number of renaming registers (RR) in a processor implementing a register renaming procedure in accordance with the execute software.

The present embodiment is designed to use a newly dedicated instruction, which is incorporated into an instruction set in order to change the number of software usable registers (SUR) and the number of renaming registers (RR). That is, the present embodiment is able to change the number of registers (SUR, RR) by issuing a dedicated instruction.

In the above, the execute software is an execute form of program (e.g. an object program written in machine languages). The execute software can be presented in the form of a source program, which is complied into an execute form of program by way of an operating system (OS) including a compiler. The present embodiment allows public users composing source programs to issue dedicated instructions. In addition, the present embodiment allows compilers (for compiling source programs into “relocatable” object programs) and resident operating systems (OS) controlling the hardware to directly or indirectly issue dedicated instructions. Therefore, any means described above are allowed to change the number of registers (SUR, RR).

Next, the dedicated instruction of the present embodiment will be described in detail. There are provides various types of dedicated instructions for increasing/decreasing the number of software usable registers (SUR), whereas the present embodiment does not always need dedicated instructions for merely increasing the number of software usable registers (SUR); in short, the present embodiment needs at least dedicated instructions for decreasing the number of software usable registers (SUR).

### (a) Dedicated Instruction-1

The dedicated instruction-1 designates an arbitrary register number in software usable registers (SUR) with an operand, wherein other registers except for the designated register are all released and set to “free” registers which are not coordinated with any of software registers (SR). Reading is not allowed for free registers. The dedicated instruction-1 has a simple function for decreasing the number of software usable registers (SUR).

### (b) Dedicated Instruction-2

Similar to the dedicated instruction-1, the dedicated instruction-2 designates an arbitrary register number (i.e. one of software usable registers (SUR)) with an operand. The dedicated instruction-2 releases only the designated software usable register (SUR), which is thus set to a free register. Reading is not allowed for such a free register. The dedicated instruction-2 has a simple function for decreasing the number of software usable registers (SUR).

### (c) Dedicated Instruction-3

The dedicated instruction-3 designates an arbitrary register number with an operand. A bit whether to designate “releasing” or “securing” registers is added to the operand. The “releasing” dedicated instruction-3 operates similarly as the dedicated instruction-1 so that it releases all the registers except for one register designated by the operand. Reading is not allowed for released registers which are regarded as free registers. In accordance with the “securing” dedicated instruction-3, a free software usable register (SUR), which is listed before the designated register number, is coordinated with one of software registers (SR). When no data is yet to be written into a software usable register (SUR), which is coordinated with the corresponding software register (SR) in accordance with the dedicated instruction-3, reading is not allowed so that its value is undefined.

### (d) Dedicated Instruction-4

The dedicated instruction-4 designates an arbitrary register number with an operand, which includes a bit whether to “releasing” or “securing” registers. The “releasing” dedicated instruction-4 operates similarly as the dedicated instruction-2 so that it releases only the register designated by the operand. In accordance with the “securing” dedicated instruction-4, the designated software usable register (SUR) is solely coordinated with the corresponding software register (SR). The dedicated instruction-4 for releasing the already released software usable register (SUR) and the dedicated instruction for securing the already secured software usable registers (SUR) lead to no operations, so that they are invalid.

Next, the operation for decreasing the number of software usable registers (SUR) will be described in conjunction with FIG. 4.

In order to decrease the number of software usable registers (SUR), it is necessary to issue the dedicated instruction-1 for releasing registers. Upon receiving the dedicated instruction-1 from the pre-renaming instruction buffer 1, the instruction analysis and request generation unit 21 sends the logical register release instruction P5 to the renaming table 52.

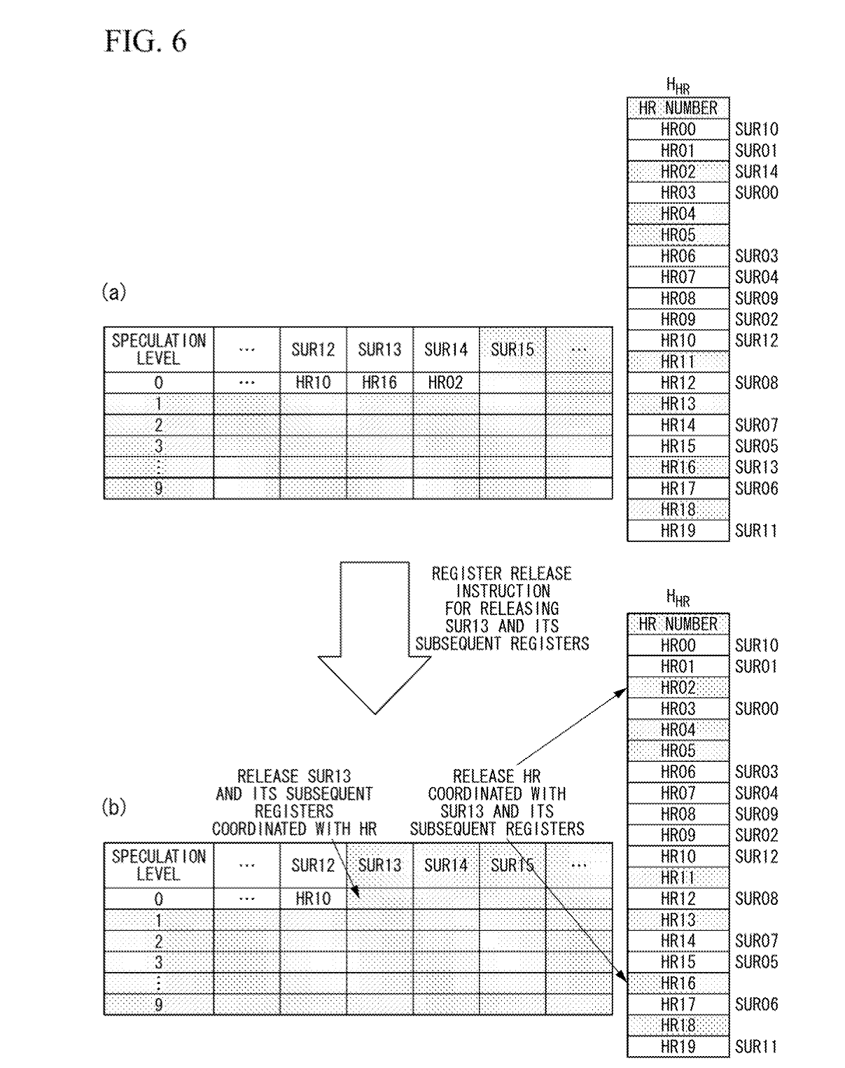

FIG. 6 illustrates the transformation of the renaming table 52 upon receipt of the logical register release instruction P5.

Upon receiving the logical register release instruction P5, the renaming table 52 releases logical registers counted from the designated register number, while it sends the physical register release instruction P13 to the busy physical register management table 51 so as to change virtual registers (or software registers SR) coordinated with released logical registers into free registers. This operation decreases the number of software usable registers (SUR), whereby it is possible to decrease the number of software registers (SR) while increasing the number of renaming registers (RR). Other dedicated instructions (i.e. the dedicated instruction-2, dedicated instruction-3, and dedicated instruction-4) operate similarly as the dedicated instruction-1, whereas they may operate differently as to whether to release one register or a plurality of registers per each instruction.

Next, the operation for increasing the number of software usable registers (SUR) will be described in conjunction with FIG. 4.

In order to increase the number of software usable registers (SUR), it is necessary to issue the dedicated instruction-3 for releasing registers.

Upon receiving the dedicated instruction-3 from the pre-renaming instruction buffer 1, the instruction analysis and request generation unit 21 performs the aforementioned renaming operation. In the renaming operation, one software usable register (SUR) is coordinated with one software register (SR) every time one write-destined register (SUR) is designated. That is, one write-destined register is renamed as a free software usable register (SUR), which is selected in advance.

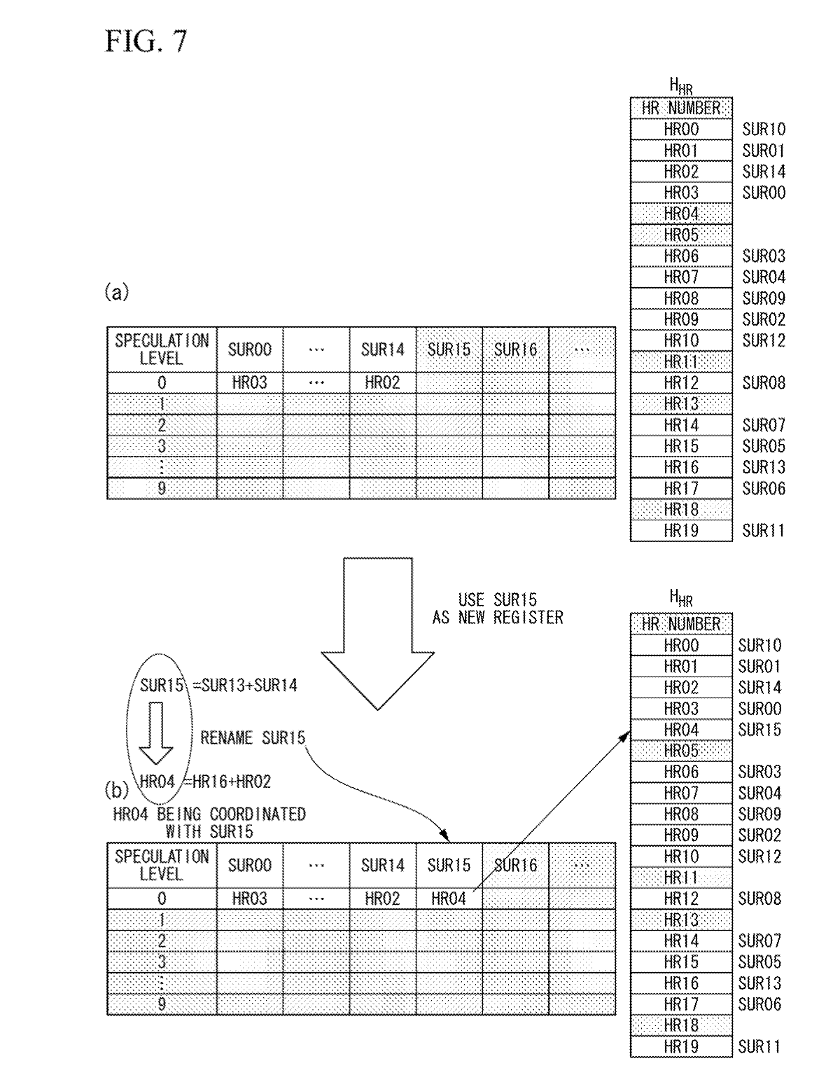

FIG. 7 illustrates the renaming operation which is initiated upon reception of a logical register securing instruction.

As shown in FIG. 7, software usable registers (SUR) are coordinated with software registers (SR). This apparently increases the number of software usable registers (SUR), whereby it is possible to increase the number of software registers (SR) while decreasing the number of renaming registers (RR).

The above description is made on a precondition that no branch instruction is made in the information processing device. Actually, however, an optimization function involved in branch instruction (i.e. a function for executing and controlling speculation) can be installed in the information processing device of the present embodiment.

Next, the operation for controlling speculation will be described below.

The speculation is to predict a branching destination and to execute instruction regarding the predicted branching destination before the determination of an actual branching destination. Since the speculation is well-known technology, the detailed explanation thereof is not described in this specification. The present embodiment introduces speculation levels in making various levels of speculations.

The speculation level management unit 23 shown in FIG. 4 manages various speculation levels in an ascending order, in which “speculation level 0” denotes that no speculation is executed; “speculation level 1” denotes that speculation is executed once; and “speculation level 2”, “speculation level 3”, . . . denotes that further speculation is executed. The renaming table 52 retains the status of each speculation level, i.e. the relationship between the registers (SUR and FIR) in each speculation level. When the speculation level is incremented by one, the renaming table 52 copies the status of the previous speculation level. In the case of “speculation success” in which the predicted branching destination turns out to be true, the renaming table 52 discards the status of speculation level 0 so that the statuses of speculation levels 1, 2, . . . are each shifted down by one level. In the case of “speculation failure” in which the predicted branching destination turns out to be false, the renaming table 52 discards all the statuses of speculation levels subsequent to the status of speculation level incurring speculation failure.

The aforementioned operation regarding dedicated instructions is performed in connection with speculation level 0. With respect to other speculation levels, the operation for increasing/decreasing software usable registers (SUR) is performed only in connection with each of speculation levels 1, 2, . . . .

The information processing device of the present embodiment improves the processing performance by way of a reduction of memory access instruction, which will be described below.

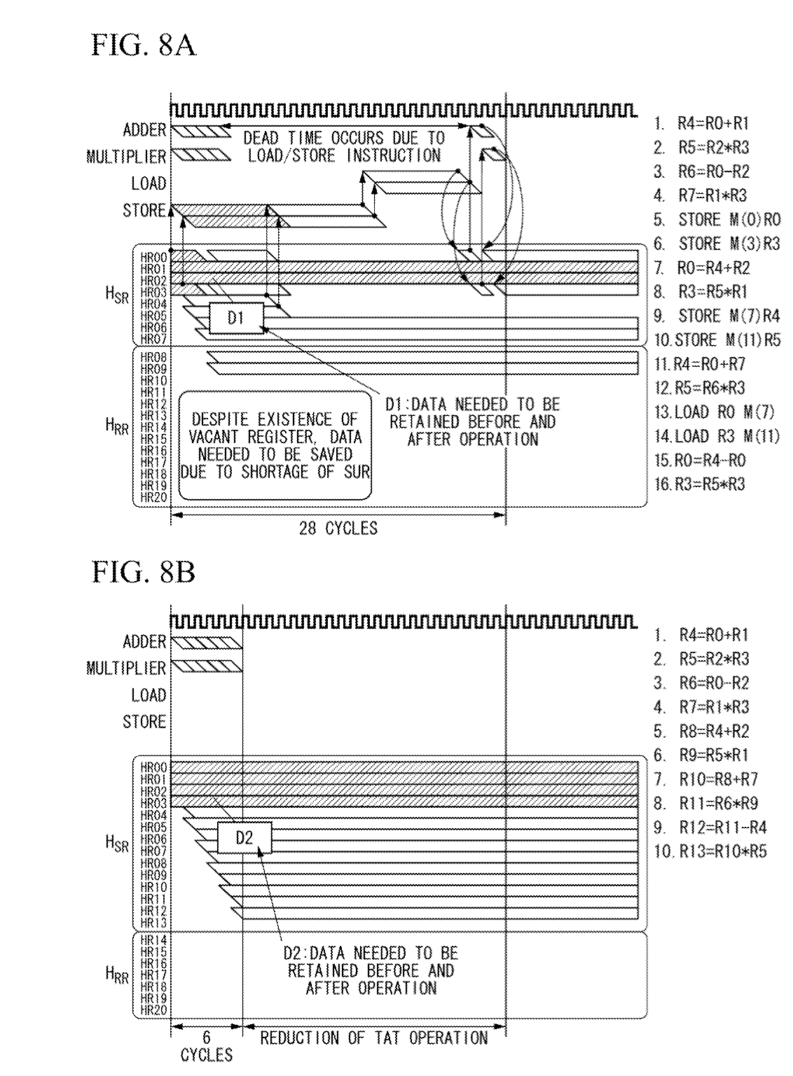

FIGS. 8A and 8B are time charts illustrating the improvement of the processing performance by way of a reduction of memory access instruction. FIG. 8A is a time chart illustrating the processing of a conventionally-known information processing device for the sake of comparison, while FIG. 8B is a time chart illustrating the processing of the information processing device of the present embodiment. The conventionally-known information processing device needs to perform a series of instructions 1-16 (see the right-side column of FIG. 8A) in connection with complex sequences (see the left-side column of FIG. 8A), in which load/store instructions are frequently needed to save data in registers due to the shortage of software usable registers (SUR). In contrast, the information processing device of the present embodiment needs to perform a series of instructions 1-10 (see the right-side column of FIG. 8B) in connection with simple sequences (see the left-side column of FIG. 8B) because it is able to increase the number of software usable registers (SUR).

Owing to the increased number of software usable registers (SUR), the instructions 1-16 shown in FIG. 8A are rewritten into instructions 1-10 shown in FIG. 8B. The time chart of FIG. 8B clearly demonstrates that the information processing device of the present embodiment does not need load/store instruction. Namely, the present embodiment certainly improves the processing performance by way of a reduction of memory access instructions.

In addition, the information processing device of the present embodiment improves the processing performance by way of elimination of a dead time for releasing registers.

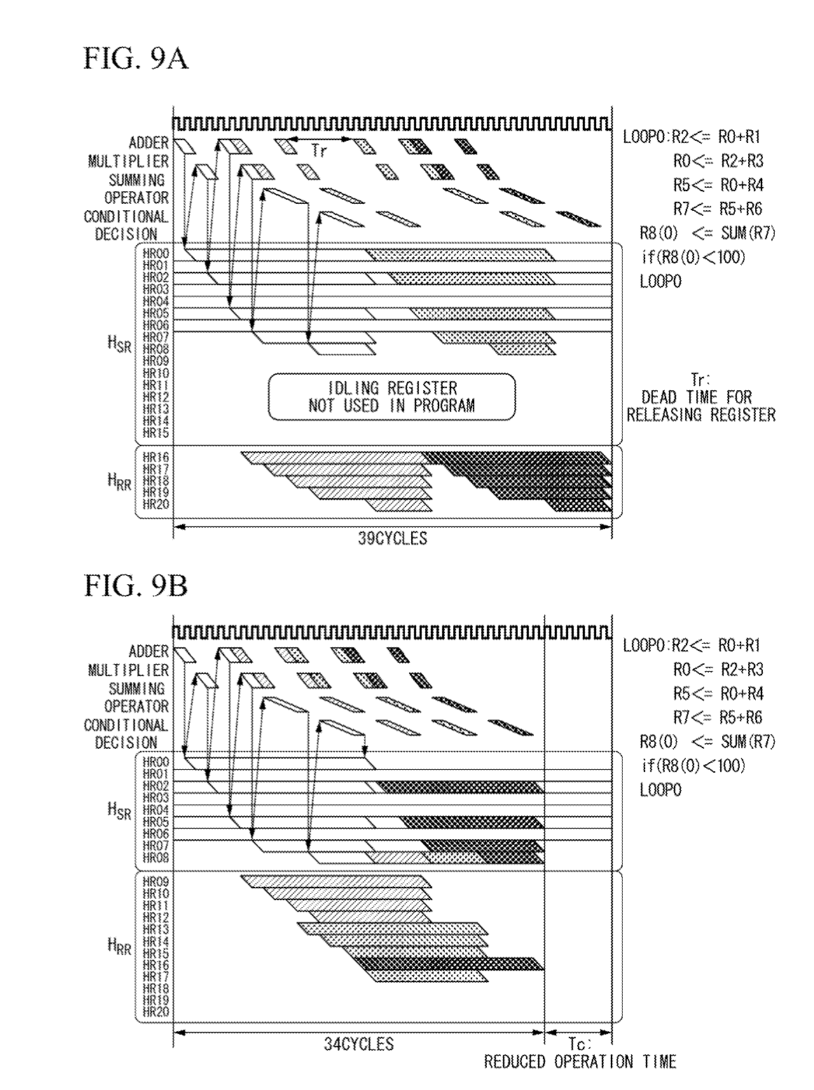

FIGS. 9A and 9B are time charts illustrating the improvement of the processing performance by way of elimination of dead time for releasing registers. FIG. 9A is a time chart illustrating the processing of a conventionally-known information processing device for the sake of comparison, and FIG. 9B is a time chart illustrating the processing of the information processing device of the present embodiment. The conventionally-known information processing device performs a series of instructions (see the right-side column of FIG. 9A), including a loop of sub-instructions, in connection with sequences (see the left-side column of FIG. 9A). Although the conventionally-known information processing device executes speculation using renaming registers (RR), it incurs dead time for releasing registers due to the shortage of renaming registers (RR). In contrast, the information processing device of the present embodiment is able to increase the number of software usable registers (SUR) as shown in FIG. 9B.

Even though the information processing device of the present embodiment performs the same program as the conventionally-known information processing device, the present embodiment is able to improve the processing performance by way of elimination of dead time for releasing registers owing to the increased number of software usable registers (SUR).

Since the present embodiment is able to change the number of software usable registers (SUR) at the arbitrary timing in view of the software, it is possible to finely optimize the ratio between registers (SR and RR) in conformity with the entire characteristics of a program and local characteristics of a program, thus achieving a high execution performance.

The information processing device of the present embodiment is able to secure the same number of registers (SR and RR) as the conventional technology (i.e. the foregoing conventionally-known information processing devices) by use of a small amount of hardware resources. The conventional technology needs a large amount of hardware resources sufficing the prerequisite number of registers (SR and RR). In contrast, the present embodiment needs a small amount of hardware resources sufficing a minimum number of software registers (SR) on condition that the number of renaming registers (RR) is smaller than the number of software registers (SR). Even when the number of renaming registers (RR) is larger than the number of software registers (SR), the present embodiment needs a relatively small amount of hardware resources sufficing a minimum number of renaming registers (RR) plus a little extra. For this reason, the present embodiment demonstrates the outstanding effect of markedly reducing the amount of hardware resources.

In addition, the present embodiment is able to reduce the power consumption owing to the reduced amount of hardware resources.

The present invention is applicable to other types of information processing devices, such as vector processors.

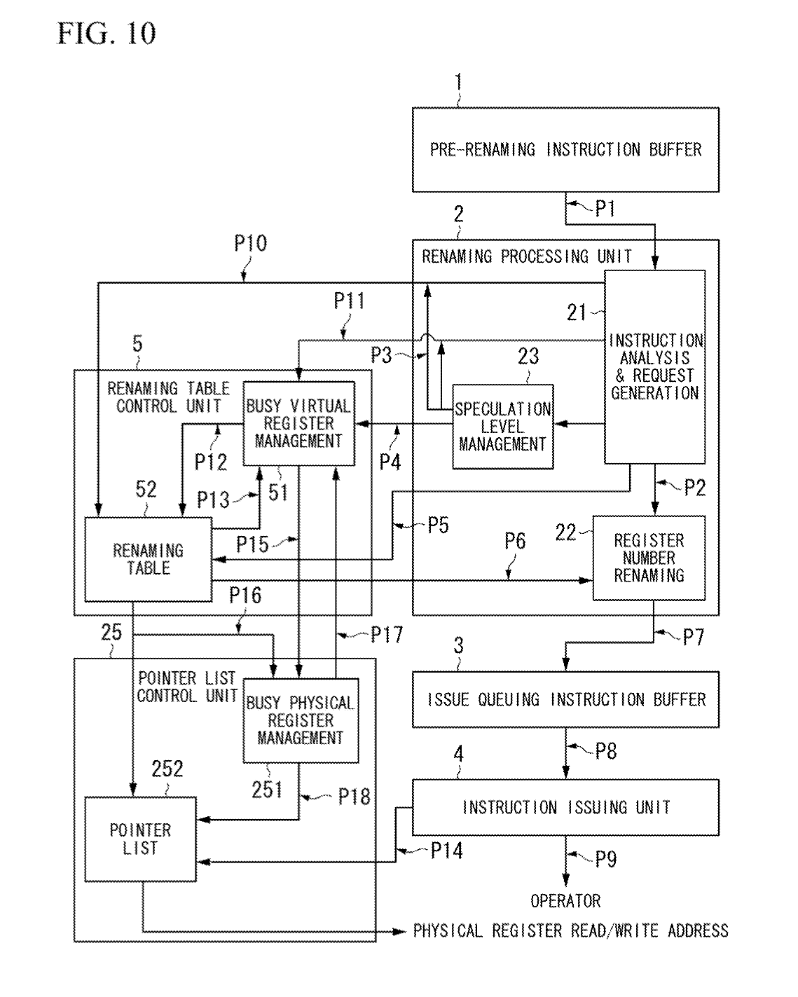

FIG. 10 is a block diagram showing the constitution of a vector information processing device, which is designed to add a pointer list control unit 2 to the constitution of the information processing device shown in FIG. 4. The pointer list control unit 25 includes a busy physical register management unit 251 and a pointer list 252. In this connection, reference numeral 51 denotes a busy virtual register management unit handling virtual registers in the renaming table control unit 5.

In FIG. 10, the pointer list control unit 25 handles a pointer instruction P14, a new physical vector register securing request P15, a physical vector register release instruction P16, a new physical vector register securing notification P17, and a pointer update instruction P18.

The overall function and operation of the busy physical register management unit 251 conform to those of the busy virtual register management unit 51. The busy pointer list 252 is equipped with a table (not shown) describing the relationship between virtual vector registers and physical vector registers (in other words, allocations of constituent elements of virtual vector registers to physical vector registers).

The vector information processing device of FIG. 10 is able to decrease the number of software usable registers (SUR) by way of a release of a virtual vector register, an elimination of an entry of the pointer list 252, and a release of a physical vector register.

The present embodiment is described in connection with the standard register renaming scheme, but there have been developed various types of register renaming schemes, which are not directly relevant to the essences of the present invention. That is, the present invention can be construed using the aforementioned expressions regarding the theory of sets; hence, the present invention is not necessarily limited by the type of the register renaming scheme.

The present invention possesses industrial applicability in connection with the architecture of information processing devices implementing register renaming schemes and pipeline processing, leading to very high processing performance.

In addition, the present invention is preferably designed to execute optimization on compilers in which objects are subjected to pipeline processing. What is claimed is:

1. An information processing device implementing a register renaming scheme for managing a plurality of physical registers coordinated with a plurality of logical registers in conjunction with a renaming table,
wherein a dedicated instruction is incorporated into an instruction set so that a physical register coordinated with a logical register designated by the dedicated instruction is released to be free, and
wherein an optimization is performed to change the number of software usable registers (SUR) within the plurality of logical registers and the number of renaming registers (RR) within the plurality of physical registers in conformity with the software executing the instruction set.

2. An information processing device implementing a register renaming scheme for managing a plurality of physical registers coordinated with a plurality of logical registers in conjunction with a renaming table,
wherein a first dedicated instruction is incorporated into an instruction set so that a free physical register is coordinated with a logical register designated by the first dedicated instruction,
wherein a second dedicated instruction is incorporated into the instruction set so that a physical register coordinated with a logical register designated by the second dedicated instruction is released to be free, and
wherein an optimization is performed to change the number of software usable registers (SUR) within the plurality of logical registers and the number of renaming registers (RR) within the plurality of physical registers in conformity with the software executing the instruction set.

3. The information processing device according to claim 1, wherein the number of software usable registers (SUR) open to the software is equal to the number of physical registers.

4. The information processing device according to claim 2, wherein the number of software usable registers (SUR) open to the software is equal to the number of physical registers.

5. The information processing device according to claim 1, wherein vector processing is performed via a pointer list connected to the renaming table.

6. The information processing device according to claim 2, wherein vector processing is performed via a pointer list connected to the renaming table.
